(19) United States
(12) Patent Application Publication
(10) Pub. No.: US 2017/0140073 A1
(43) Pub. Date: May 18, 2017

(54) ARCHITECTURE AND DESIGN AUTOMATION OF HIGH PERFORMANCE LARGE ADDERS AND COUNTERS ON FPGA THROUGH CONSTRAINED PLACEMENT

(71) Applicant: Indian Institute of Technology Kharagpur, Kharagpur, West Bengal (IN)

(72) Inventors: Rajat Subhra Chakraborty, Chandemagore, West Bengal (IN); Ayan Palchaudhuri, Kolkata, West Bengal (IN)

(73) Assignee: Indian Institute of Technology Kharagpur, Kharagpur, West Bengal (IN)

(21) Appl. No.: 15/118,120

(22) PCT Filed: Apr. 2, 2014
(86) PCT No.: PCT/IB2014/060372

§ 371 Date: Aug. 11, 2016

(30) Foreign Application Priority Data
Feb. 13, 2014 (IN) 179/KOL/2014

(51) Int. Cl. G06F 17/50

(52) U.S. Cl. CPC G06F 17/505; G06F 17/5054; G06F 17/5072; G06F 2217/06

(57) ABSTRACT

Technologies are described to automate design of field programmable gate array (FPGA) circuits, specifically for fast and efficient architectures for large integer adders and counters through direct instantiation of carry chain primitives and lookup tables in circuit description. In some examples, placement of circuits on relatively adjacent slices may be controlled such that the slices are strongly and logically coupled to enable compact placement and thereby contributing to reduced routing delay and FPGA chip area. Design descriptions and constraint files may be automatically generated by a design application providing operand-width scalability with respect to operating frequency of the designed circuit.

### BACKGROUND

Unless otherwise indicated herein, the materials described in this section are not prior art to the claims in this application and are not admitted to be prior art by inclusion in this section.

A field-programmable gate array (FPGA) is an integrated circuit designed to be configured by a customer or a designer after manufacturing. The FPGA configuration may be specified using a hardware description language (HDL), similar to that used for an application-specific integrated circuit (ASIC). FPGAs may have large resources of logic gates and RAM blocks to implement complex digital computations. The ability to reconfigure the functionality multiple times during its lifetime, partial re-configuration of a portion of the circuit design, and the low non-recurring engineering costs relative to an ASIC design may offer advantages to FPGAs for many applications.

With substantial increase in circuit complexity for FPGA-based designs, even the sophisticated computer aided design (CAD) tools may often provide circuit implementations with unsatisfactory performance and resource requirements due to the tools' inability to optimally or otherwise efficiently exploit the underlying FPGA architecture and their dedicated routing fabric. As a result, designed circuits may occupy a larger FPGA chip area, and the associated power consumption and interconnect delays may be higher. Hence, implementations derived through the standard automatic logic synthesis based design flow starting with the behavioral description of the circuit in HDL may often not be the methodology of choice, especially for circuits with large operand width.

### SUMMARY

The present disclosure generally describes methods, apparatus, systems, devices, and/or computer program products to provide architecture and design automation of high performance large adders and counters on field programmable gate arrays (FPGAs) through constrained placement.

In some examples, various methods are described to provide design automation of large adders and counters on field programmable gate arrays (FGPAs) through constrained placement. An example method may include mapping base elements associated with a circuit design to one or more configurable logic blocks of an FPGA platform, where the configurable logic blocks include one or more of adders and/or counters. The example method may further include defining one or more placement constraints for the base elements and generating a placement output associated with the circuit design based on the mapped base elements and the one or more placement constraints.

In other examples, a circuit design tool is described to facilitate design automation of large adders and counters on field programmable gate arrays (FGPAs) through constrained placement. An example circuit design tool may include a presentation module that includes a graphical user interface (GUI) displayable on a display screen, where the presentation module is configured to facilitate definition of one or more placement constraints and selection of base elements associated with a circuit design; an input module coupled to the presentation module and configured to receive the definition of the one or more placement constraints and the selected base elements through the GUI; and a placement module coupled to the input module. The placement module may be configured to map the selected base elements of the circuit design into one or more configurable logic blocks of an FPGA platform, where the configurable logic blocks include one or more of adders and/or counters; implement the one or more defined placement constraints; and generate a placement output for the circuit design based on the mapped base elements and the one or more placement constraints.

In further examples, a non-transitory computer-readable storage medium is described that includes instructions stored thereon to facilitate design automation of large adders and counters on field programmable gate arrays (FGPAs) through constrained placement. The instructions may be executable by a processor to cause a method to be performed, where the method includes mapping base elements associated with a circuit design to one or more configurable logic blocks of an FPGA platform, where the configurable logic blocks include one or more of adders and/or counters; defining one or more placement constraints for the base elements such that routing and/or interconnect delays in the circuit design and a number of hardware components in the circuit design and/or an occupied chip area are reduced; and generating a placement output associated with the circuit design based on the mapped base elements and the one or more placement constraints.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The below described and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example basic building block for a pipelined implementation of a hybrid ripple carry adder;

FIG. 2 illustrates an example fast adder architecture;

FIG. 3 illustrates an example architecture for a loadable, up/down counter;

FIG. 4A illustrates an example digital signal processing (DSP) based counter circuit;

FIG. 4B illustrates an example digital signal processing (DSP) based adder circuit;

FIG. 5 illustrates an example architecture for a fast carry generator circuit;

FIG. 6 illustrates a general purpose computing device, which may be used to implement a circuit design tool as described herein;

FIG. 7 illustrates a special purpose processor, which may be used to implement a circuit design tool as described herein;

FIG. 8 is a flow diagram illustrating an example method to provide architecture and design automation of high performance large adders and counters on field programmable gate arrays (FGPAs) through constrained placement that may be performed or otherwise controlled by a computing device such as the computing device in FIG. 6 or the special purpose processor of FIG. 7; and

FIG. 9 illustrates a block diagram of an example computer program product to implement a circuit design tool as described herein;

all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, and/or computer program products to provide architecture and design automation of high performance large adders and counters on field programmable gate arrays (FGPAs) through constrained placement.

Briefly stated, technologies are described to automate the design of field programmable gate array (FPGA) circuits, specifically for fast and efficient architectures for large integer adders and counters through direct instantiation of carry chain primitives and lookup tables in circuit description. In some examples, placement of circuits on relatively adjacent slices may be controlled such that the slices are strongly and logically coupled to enable compact placement and thereby contributing to reduced routing delay and FPGA chip area. Design descriptions and constraint files may be automatically generated by a design application providing operand-width scalability with respect to the operating frequency of the designed circuit.

FPGAs may contain programmable logic components called “configurable logic blocks”, and a hierarchy of reconfigurable interconnects that allow the blocks to be wired together in different configurations. The configurable logic blocks may be configured to perform complex combinational functions or may be relatively more simple logic gates like AND and XOR gates. While example embodiments are described herein using mainly adders and counters, automated design of FPGA circuits may also be implemented using other logic blocks such as subtractors, multipliers, dividers, rotators, shifters, inverters, OR blocks, AND blocks, XOR blocks, XNOR blocks, NAND blocks, NOR blocks, registers, flip-flops, latches and/or other element(s) and combination(s) thereof.

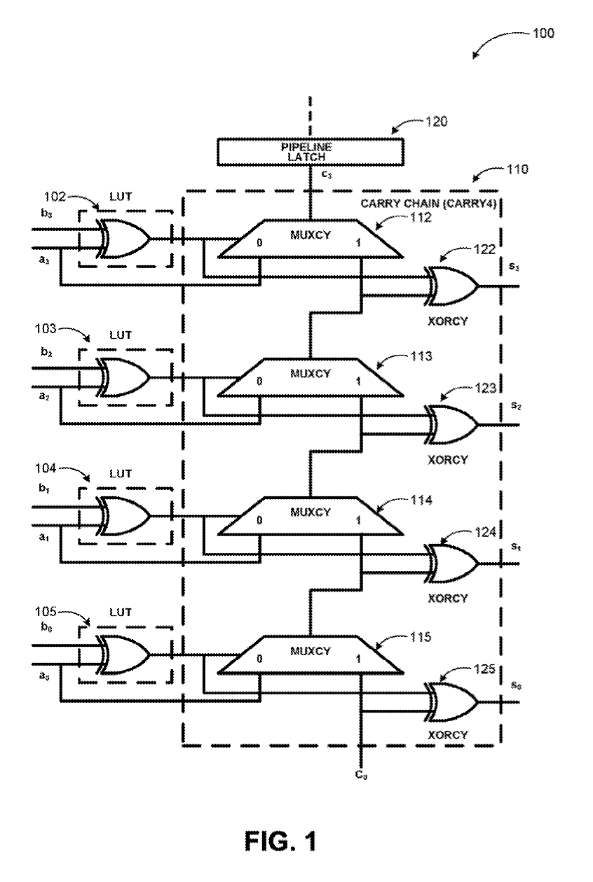

FIG. 1 illustrates an example basic building block for a pipelined implementation of a hybrid ripple carry adder, arranged in accordance with at least some embodiments described herein.

Diagram 100 shows a basic building block for realization of a large pipelined “ripple carry adder” (RCA) or “hybrid ripple carry adder” (Hybrid RCA). The basic building block may include a carry chain 110 with a series of multiplexers for carry propagation logic (MUXCY) 112-115 and a series of XOR gates for computing sum bits (XORCY) 122-125. The basic building block may further include a look-up table (LUT) for each carry logic (LUTs 102-105) and a pipeline latch 120. While the basic building block in diagram 100 is shown with four carry logic blocks (4-bit adder), that is an illustrative example. Embodiments may be implemented with the supported number of carry logic blocks in the carry chain 110 and corresponding LUTs.

In one example embodiment, the basic building block may be a 4-bit adder realized within a single slice of an FPGA, as shown in diagram 100. The outputs of the XORCY gates 122-125 may provide the sum bits, whereas the output of each MUXCY (112-115) may compute the intermediate carries. Latches may be inserted on the carry propagation path for pipelining the design (pipeline latch 120). If pipelined, the hybrid RCA may result in [n/4]−1 pipeline stages, where n represents the maximum operand with out of the 2 addends. Four cascaded MUXCYs along with the four XORCY gates together may form a single carry chain that may be directly instantiated as a primitive.

Adders may also be realized using DSP slices of FPGA. For example, in some designs, each slice may accept operands with a width of 48 bits. To realize adders with larger operand width (n>48), [n/48] slices may be implemented, and such designs may be pipelined by activating the pipeline registers internal to the slices. An (n>48)-bit pipelined slice based adder may involve [n/48]−1 pipeline stages.

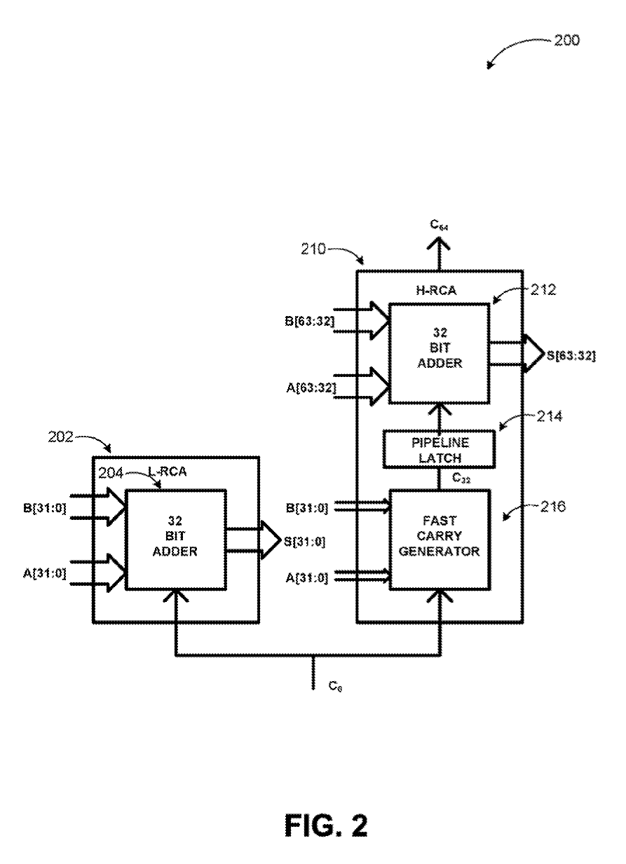

FIG. 2 illustrates an example fast adder architecture, arranged in accordance with at least some embodiments described herein.

The fast adder architecture in diagram 200 includes two portions 202 and 210. The portion 202 may include a pipelined hybrid lower ripple carry adder (L-RCA) 204, which may be implemented as a 32-bit adder according to some example embodiments. The other portion 210 may include a pipelined hybrid higher ripple carry adder (H-RCA) 212 also comprising a 32-bit adder. The other portion 210 may further include a fast carry generator 216 and a pipeline latch 214.

Thus, in an example embodiment, an n-bit adder may be divided into two independent, substantially identical portions L-RCA and H-RCA, each of which may compute n/2 sum bits (assuming n to be even). The H-RCA 212 may receive its carry input from the fast carry generator 216. Both the L-RCA 204 and H-RCA 212 may be architecturally identical to the pipelined implementation of the RCA shown in FIG. 1. The architecture of the fast adder architecture shown in diagram 200 may be implemented for 64-bit operands.

The pipeline latency of the adder on a whole may be based on the number of pipeline stages for the H-RCA 212 and the fast carry generator 216. The n/2 bit H-RCA may result in [n/8]−1 pipeline stages, while the n/2 bit fast carry generator may result in [n/16]−1 pipeline stages. Thus, an n-bit fast carry adder may result in [3n/16]−1 pipeline stages, including the pipeline stage between the fast carry generator 216 and the H-RCA 212.

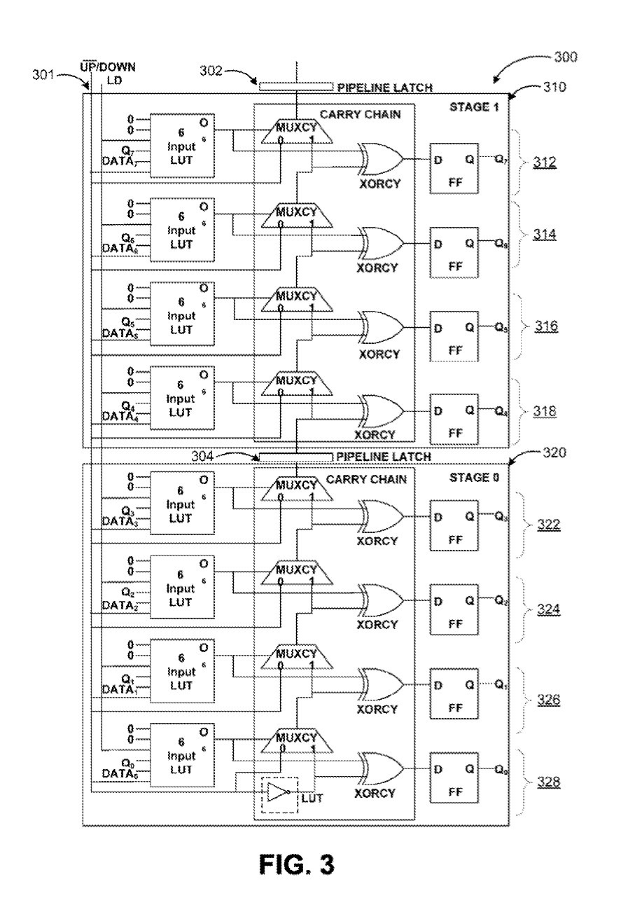

FIG. 3 illustrates an example architecture for a loadable, up/down counter, arranged in accordance with at least some embodiments described herein.

Diagram 300 shows a two-stage large counter according to some embodiments. The large up/down counter may include a stage 0 (320) with four blocks 322, 324, 326, and 328 embedded in a single slice, each block including a LUT coupled to a carry chain block, which in turn may be coupled to a parallel-in-parallel-out (PIPO) circuit realized using a D flip-flop (D-FF) for example. Stage 0 (320) may be coupled through a pipeline latch 304 to stage 1 (310), which may include identical four blocks 312, 314, 316, and 318 embedded in a single slice. Stage 1 (310) may also be coupled to another pipeline latch 302. The pipeline latches may be D-FFs with clock enable and asynchronous preset and clear. An up/down line 301 may control the incrementing/decrementing operation as shown in FIG. 3.

Example features may include a counter that may be resettable, loadable, reversible (up/down counter), count enabled, can be read on-the-fly and be able to detect terminal count. An up/down counter, as shown in diagram 300, may be realized as a combination of a D-FF based PIPO register and an incrementer/decrementer, which may accept the output of the register as its input, and feedback its outputs to the input of the register. The outputs may come as feedback to LUT inputs and not directly to PIPO register. If the counter output as indicated by the FF outputs are Qₙ₋₁, Qₙ₋₂, . . . Q₁, Q₀, then the D-inputs of the FFs for an up-counter may be defined by:

D₀=Q̅₀ [1]

Dᵢ=Q̅ᵢ⊕(Qᵢ₋₁Qᵢ₋₂ . . . Q₁Q₀) if i≧1 [2]

Similarly, the D-inputs of the FFs for a down-counter may be defined by:

D₀=Q̅₀ [3]

Dᵢ=Q̅ᵢ⊕(Qᵢ₋₁+Qᵢ₋₂+ . . . +Q₁+Q₀) if i≧1. [4]

Equations (2) and (4) may suggest that an AND and OR logic may have to be realized which may be configured using the carry chain as shown in diagram 300. Thus, larger counters may be realized by successive cascading of the stage 1 (310) block. The PIPO registers may be realized using the D-FF primitive with synchronous reset, set, and clock enable. Pipeline latency may affect the correct functionality of the counters and may not be tolerated in the counter, as the inputs to the PIPO register come at a specific instant of time and outputs may be expected to be obtained in the following clock cycle. Hence, the pipelined latches may be realized using a D-FF primitive with clock enable and asynchronous preset and clear. These FFs may be preset if the output from the previous carry chain of the adjacent configurable logic block is high and cleared if low. For an n-bit counter, [n/4]−1 pipeline stages may be implemented.

As discussed herein, high performance large binary counters, whose architecture is shown in diagram 300, may be implemented using constrained placement of the circuit building blocks on the FPGA fabric and pipelining according to some embodiments. A circuit design tool according to other embodiments may be used to automate the design and placement of the counter, as well as adders such as hybrid pipelined ripple carry adders and fast adders discussed herein.

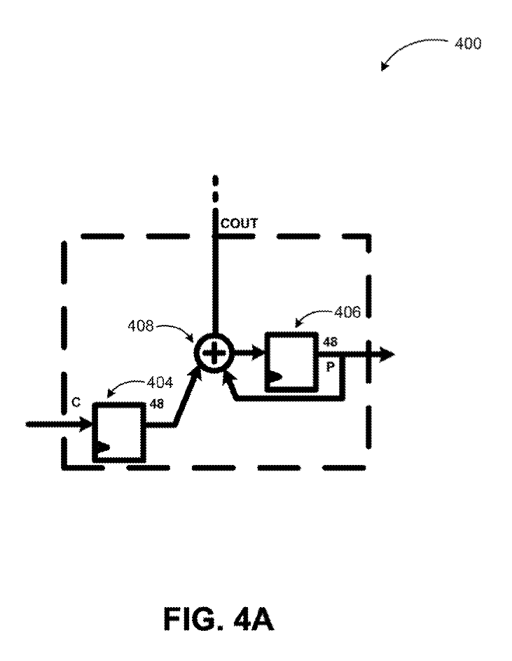

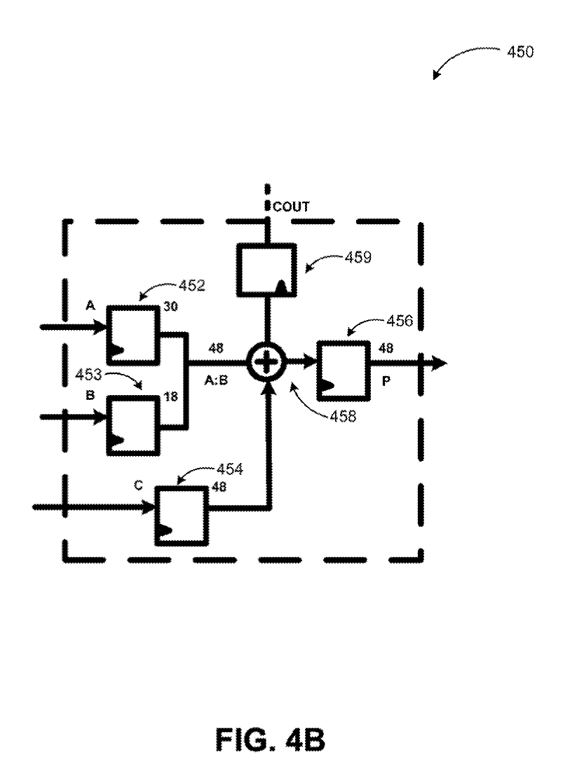

FIG. 4A illustrates and example digital signal processing (DSP) based counter circuit, arranged in accordance with at least some embodiments described herein.

Diagram 400 shows the example counter circuit realized using two 48-bit registers 404 and 406, and a summer 408. Both the external data to be loaded or the carry input may be provided to register 404, whose output may be summed at the summer 408 with an output of the register 406. Thus, register 406 may be used as feedback into the counter. The output of register 406 provides the counting output.

FIG. 4B illustrates and example digital signal processing (DSP) based adder circuit, arranged in accordance with at least some embodiments described herein.

Diagram 450 shows the example adder circuit realized using 30, 18, 48 and 48 bit registers 452, 453, 454, 456, respectively, a flip-flop (FF) 459, and a summer 458. The external data to be loaded may be provided to registers 452 and 453, while the carry input may be provided to register 454. The outputs of registers 452, 453, and 454 may be summed at the summer 458, whose output may be provided to register 456 and to FF 459.

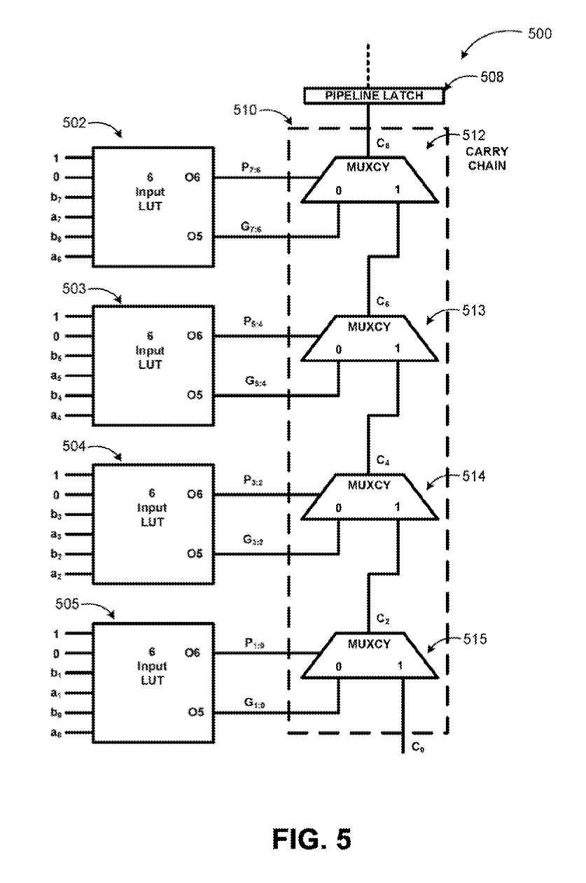

FIG. 5 illustrates an example architecture for a fast carry generator circuit, arranged in accordance with at least some embodiments described herein.

The fast carry generator shown in diagram 500 may include four input LUTs 502-505 and corresponding MUXCYs 512-515 forming the carry chain 510. The carry chain 510 may be coupled to pipeline latch 508 to address latency.

In the architecture depicted in diagram 500, the Boolean logic functions G_{i:j} and P_{i:j} may be computed using the example 6-input LUTs 502-505, where i=j+1, and m=1+1=j+2. G_{i:j} and P_{i:j} may respectively denote group propagated carry and group generated carry functions for group of bit positions i, i−1, . . . j (with i≧j). P_{i:j} may be 1 when an incoming carry into the least significant position j, cⱼ, is allowed to propagate through all i−j+1 bit positions. G_{i:j} may be 1 when a carry is generated in at least one of the bit position from j to i (both inclusive), and propagates to bit position i+1, i.e., the outgoing carry cᵢ₊₁=1. Thus:

$$\begin{matrix}{P}_{i \text{:} j} = \{ \begin{matrix}{P}_{i} , if i = j \\ {P}_{i} {P}_{i - 1 \text{:} j} , if i \geq j\end{matrix} & [ 5 ] \\ {G}_{i \text{:} j} = \{ \begin{matrix}{G}_{i} , if i = j \\ {G}_{j} + {P}_{j} {G}_{i - 1 \text{:} j} , if i \geq j\end{matrix} , \\ where {P}_{i} = {a}_{i} ⊕ {b}_{i} and {G}_{i} = {a}_{i} {b}_{i} , & [ 6 ]\end{matrix}$$

Carry output may be computed using the carry chain. Using the example configuration of the fast carry generator, the carry output may be obtained from the previous carry output with a single multiplexer of the carry chain. In contrast, a conventional ripple carry adder chain may compute the carry output from the previous carry output using two multiplexers of the carry chain.

The examples in FIGS. 1 through 5 have been described using specific circuits, processes, and applications in which design automation of FPGA circuits may be implemented. Embodiments are not limited to the circuits, processes, and applications according to these examples.

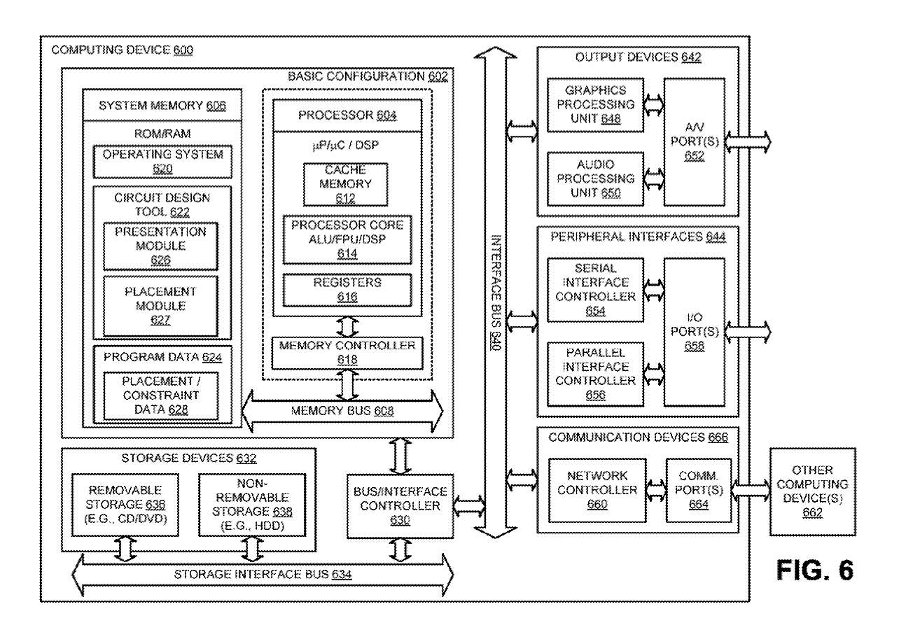

FIG. 6 illustrates a general purpose computing device, which may be used to implement a circuit design tool as described herein, arranged in accordance with at least some embodiments described herein.

For example, the computing device 600 may be used to manage or otherwise control a design process of an FPGA as described herein. In an example basic configuration 602, the computing device 600 may include one or more processors 604 and a system memory 606. A memory bus 608 may be used for communicating between the processor 604 and the system memory 606. The basic configuration 602 is illustrated in FIG. 6 by those components within the inner dashed line.

Depending on the desired configuration, the processor 604 may be of any type, including but not limited to a microprocessor (pP), a microcontroller (pC), a digital signal processor (DSP), or any combination thereof. The processor 604 may include one more levels of caching, such as a level cache memory 612, a processor core 614, and registers 616. The example processor core 614 may include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, a circuit design tool 622, and program data 624. The circuit design tool 622 may include a presentation module 626 and a placement module 627. The presentation module 626 may include a graphical user interface (GUI) displayable on a display screen, and be configured to facilitate definition of one or more constraints and selection of base elements associated with a circuit design. The base elements may be adders and counters themselves. The placement module 627 may map the selected base elements of the circuit design into one or more configurable logic blocks of an FPGA platform, implement the one or more defined placement constraints associated with the base elements, and generate a placement output for the circuit design based on the mapped base elements and the one or more placement constraints as described herein. The program data 624 may include placement and/or constraint data 628, as well as other data usable in connection with the embodiments described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more AN ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example communication device 646 includes a network controller 660, which may be arranged to facilitate communications with one or more other computing devices 662 over a network communication link via one or more communication ports 664. The one or more other computing devices 662 may include servers at a datacenter, customer equipment, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

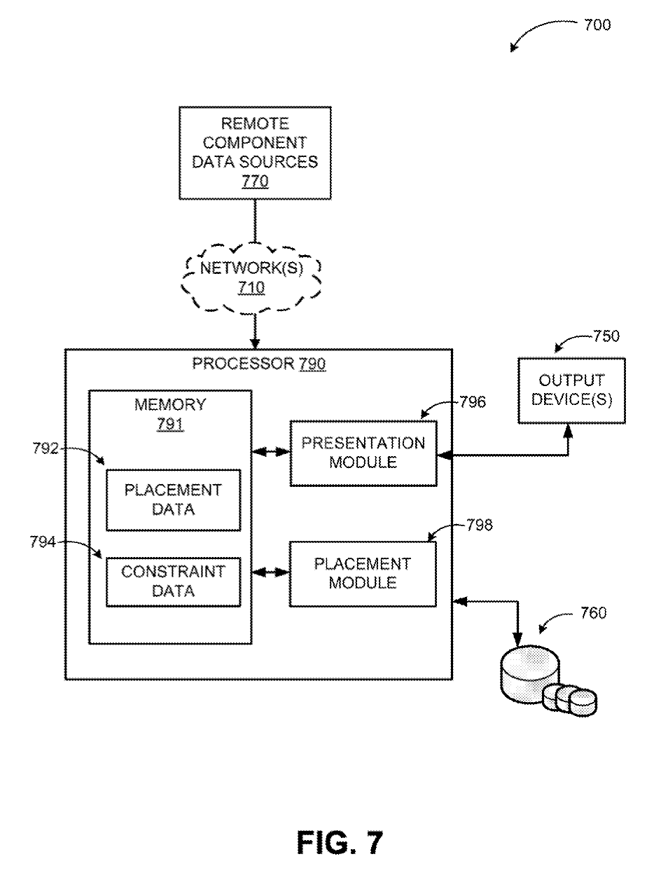

FIG. 7 illustrates a special purpose processor, which may be used to implement a circuit design tool as described herein, arranged in accordance with at least some embodiments described herein.

Processor 790 may be part of a design system or manufacturing system. In one embodiment, processor 790 may be implemented as processor 604 of FIG. 6. Processor 790 may communicate with remote component data sources 770 over through network(s) 710 to provide design automation and/or manufacturing/programming of FPGAs. Processor 790 may also communicate with data sources 760 configured to store circuit design related information. Upon completion, circuit designs (placement outputs) may be provided to a user through output devices 750 or directly to FPGA programming devices.

Processor 790 may include a number of processing modules such as a presentation module 796 and placement module 798. Presentation module 796 may include a graphical user interface (GUI) displayable on a display screen, and facilitate definition of one or more constraints and selection of base elements associated with a circuit design. Placement module 798 may map the selected base elements of the circuit design into one or more configurable logic blocks of an FPGA platform, implement the defined placement constraints associated with the base elements, and generate the placement output for the circuit design based on the mapped base elements and the placement constraints. Placement data 792 and constraint data 794 may be used by processor 790 in conjunction with the placement module 798 to perform automated FPGA circuit design. Placement data 792 and constraint data 794 may be stored during processing in memory 791, which may be a cache memory of the processor 790 or an external memory (e.g., memory external to processor 790).

Example embodiments may also include methods to automate design of FPGA circuits. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be with a machine that performs a portion of the program. In other examples, the human interaction can be automated such as by pre-selected criteria that may be machine automated.

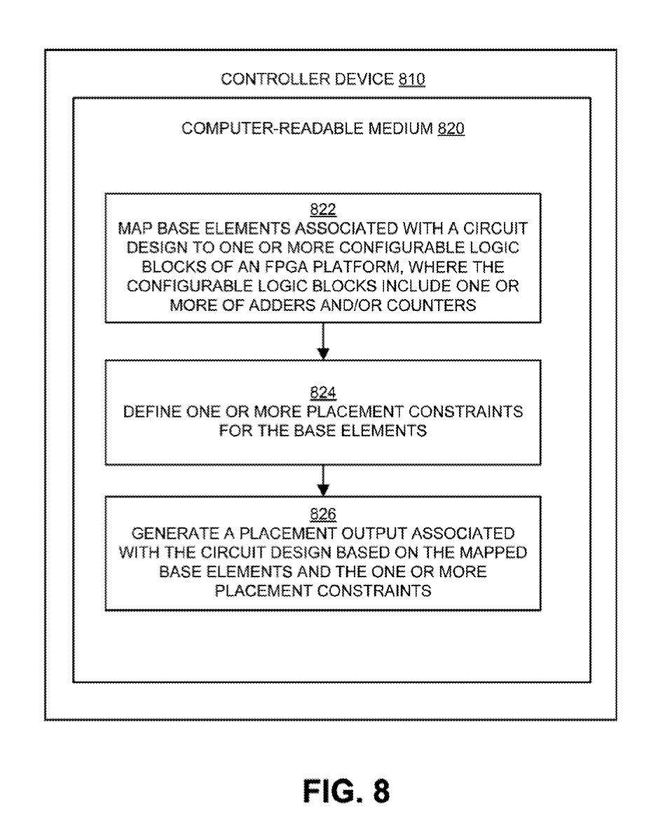

FIG. 8 is a flow diagram illustrating an example method to provide architecture and design automation of high performance large adders and counters on field programmable gate arrays (FGPAs) through constrained placement that may be performed or otherwise controlled by a computing device such as the computing device in FIG. 6 or the special purpose processor of FIG. 7, arranged in accordance with at least some embodiments described herein.

Example methods may include one or more operations, functions or actions as illustrated by one or more of blocks 822, 824, and/or 826, and may in some embodiments be performed by a computing device such as the computing device 600 in FIG. 6 or the special purpose processor 790 in FIG. 7. The operations described in the blocks 822-826 may also be stored as computer-executable instructions in a non-transitory computer-readable medium such as a computer-readable medium 820 of a computing device 810, and executable by one or more processors.

An example process to provide design automation of large adders and counters on FGPAs through constrained placement may begin with block 822, “MAP BASE ELEMENTS ASSOCIATED WITH A CIRCUIT DESIGN TO ONE OR MORE CONFIGURABLE LOGIC BLOCKS OF AN FPGA PLATFORM, WHERE THE CONFIGURABLE LOGIC BLOCKS INCLUDE ONE OR MORE OF ADDERS AND/OR COUNTERS”, where the placement module 627 may map base elements associated with a circuit design to one or more configurable logic blocks. The configuration blocks may include adders, counters, subtractors, multipliers, dividers, rotators, shifters, inverters, OR blocks, AND blocks, XOR blocks, XNOR blocks, NAND blocks, NOR blocks, registers, flip-flops, latches, and/or other element(s) or combination(s) thereof.

Block 822 may be followed by block 824, “DEFINE ONE OR MORE PLACEMENT CONSTRAINTS FOR THE BASE ELEMENTS”, where the placement module 627 may define the constraints for the base element such that routing and/or interconnect delays in the circuit design and a number of hardware components in the circuit design and/or an occupied chip area are reduced. In some example embodiments, the constraints may be defined during design synthesis.

Block 824 may be followed by block 826, “GENERATE A PLACEMENT OUTPUT ASSOCIATED WITH THE CIRCUIT DESIGN BASED ON THE MAPPED BASE ELEMENTS AND THE ONE OR MORE PLACEMENT CONSTRAINTS”, where the placement module 627 may generate the placement output for the FPGA circuit design. The placement module 627 may generate the placement output by cascading one or more of ripple carry adders and/or hybrid ripple carry adders. The placement module 627 may also generate the placement output for a fast adder by splitting an n-bit adder into two independent portions, a pipelined hybrid lower ripple carry adder “L-RCA” and a pipelined hybrid higher ripple carry adder “H-RCA”, where each of the two independent portions correspond to n/2 sum bits and n corresponds to a number of bits that can be processed by the adder.

The operations included in the process of FIG. 8 described above are for illustration purposes. Architecture and design automation of high performance large adders and counters on FPGAs through constrained placement that may be performed or otherwise controlled by similar processes with fewer or additional operations, for example, further optimization operations may be added. In some examples, the operations may be performed in a different order. In some other examples, various operations may be eliminated. In still other examples, various operations may be divided into additional operations, supplemented with other operations, or combined together into fewer operations. Although illustrated as sequentially ordered operations, in some implementations, the various operations may be performed in a different order, or in some cases, various operations may be performed at substantially the same time.

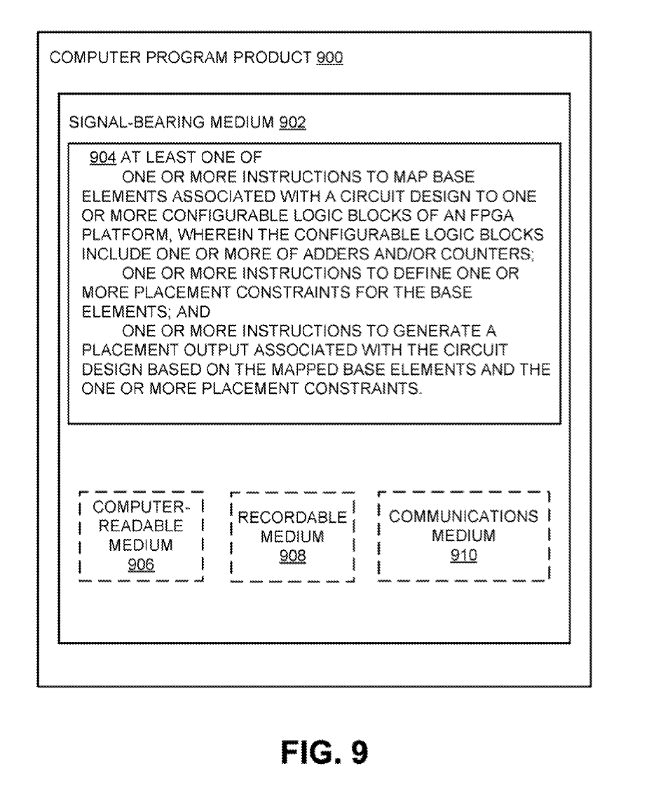

FIG. 9 illustrates a block diagram of an example computer program product to implement a circuit design tool as described herein, arranged in accordance with at least some embodiments described herein.

In some examples, as shown in FIG. 9, the computer program product 900 may include a signal bearing medium 902 that may also include one or more machine readable instructions 904 that, in response to execution by, for example, a processor may provide the features and operations described herein. Thus, for example, referring to the processor 604 in FIG. 6, the circuit design tool 622, the presentation module 626, or the placement module 627 may undertake one or more of the tasks shown in FIG. 9 in response to the instructions 904 conveyed to the processor 604 by the medium 902 to perform actions associated with implementing an automated design tool for FPGA circuits as described herein. Some of those instructions may be, for example, to map base elements associated with a circuit design to one or more configurable logic blocks of an FPGA platform, where the configurable logic blocks include one or more of adders and/or counters; to define one or more placement constraints for the base elements; and to generate a placement output associated with the circuit design based on the mapped base elements and the one or more placement constraints, according to some embodiments described herein.

In some implementations, the signal bearing medium 902 depicted in FIG. 9 may encompass a computer-readable medium 906, such as, but not limited to, a hard disk drive, a solid state drive, a Compact Disc (CD), a Digital Versatile Disk (DVD), a digital tape, memory, etc. In some implementations, the signal bearing medium 902 may encompass a recordable medium 908, such as, but not limited to, memory, read/write (R/W) CDs, R/W DVDs, etc. In some implementations, the signal bearing medium 902 may encompass a communications medium 910, such as, but not limited to, a digital and/or an analog communication medium (for example, a fiber optic cable, a waveguide, a wired communications link, a wireless communication link, etc.). Thus, for example, the program product 900 may be conveyed to one or more modules of the processor 604 by an RF signal bearing medium, where the signal bearing medium 902 is conveyed by the wireless communications medium 910 (for example, a wireless communications medium conforming with the IEEE 802.11 standard).

In some examples, various methods are described to provide design automation of large adders and counters on field programmable gate arrays (FGPAs) through constrained placement. An example method may include mapping base elements associated with a circuit design to one or more configurable logic blocks of an FPGA platform, where the configurable logic blocks include one or more of adders and/or counters. The example method may further include defining one or more placement constraints for the base elements and generating a placement output associated with the circuit design based on the mapped base elements and the one or more placement constraints.

In other examples, defining the one or more constraints may include defining the one or more constraints so as to reduce routing and/or interconnect delays in the circuit design. Defining the one or more constraints may also include defining the one or more constraints so as to reduce a number of hardware components in the circuit design and/or an occupied chip area. Defining the one or more placement constraints may further include defining the one or more constraints during design synthesis. The method may also include employing a carry-chain primitive as a hardware primitive.

In further examples, mapping the base elements associated with the circuit design to the one or more configurable logic blocks may include employing a 4-bit adder in a single slice of a configurable logic block. The method may further include implementing one of a ripple carry adder and a hybrid ripple carry adder from the 4-bit adder on a single slice of the FPGA platform using one or more look-up tables (LUTs), multiplexers for carry propagation logic (MUXCYs), XOR gates for computing sum bits (XORCYs), and/or flip-flops (FF). Implementing one of the ripple carry adder and the hybrid ripple carry adder may include implementing the one of the ripple carry adder and the hybrid ripple carry adder such that outputs of the XORCYs correspond to sum bits and outputs of the MUXCYs correspond to intermediate carries.

In yet other examples, the method may also include implementing a hybrid ripple carry adder from the 4-bit adder on a single slice of the FPGA platform, wherein the hybrid ripple carry adder includes two or more pipeline stages when pipelining is employed. The method may yet include inserting latches on a carry propagation path for pipelining. Generating the placement output associated with the circuit design may include generating the placement output for the circuit design by cascading one or more of ripple carry adders and/or hybrid ripple carry adders. Generating the placement output associated with the circuit design may include generating the placement output for a fast adder by splitting an n-bit adder into two independent portions, a pipelined hybrid lower ripple carry adder “L-RCA” and a pipelined hybrid higher ripple carry adder “H-RCA”, each of the two independent portions corresponding to n/2 sum bits, where n corresponds to a number of bits that can be processed by the adder.

In yet further examples, generating the placement output associated with the circuit design may include generating the placement output for an up/down counter as a combination of a flip-flop based parallel-in parallel-out (PIPO) register and an incrementer/decrementer, where the generated placement output accepts an output of the PIPO register as input, and provides outputs as feedback to an input of the PIPO register. Generating the placement output associated with the circuit design may further include generating the placement output for a large counter circuit as cascaded stages, where the generated placement output of the PIPO register includes a flip-flop with a synchronous reset, a synchronous set, and a synchronous clock enable. The method may also include providing a graphical user interface (GUI) to enable definition of the one or more constraints and selection of the base elements.

In other examples, a circuit design tool is described to facilitate design automation of large adders and counters on field programmable gate arrays (FGPAs) through constrained placement. An example circuit design tool may include a presentation module that includes a graphical user interface (GUI) displayable on a display screen, where the presentation module is configured to facilitate definition of one or more placement constraints and selection of base elements associated with a circuit design; an input module coupled to the presentation module and configured to receive the definition of the one or more placement constraints and the selected base elements through the GUI; and a placement module coupled to the input module. The placement module may be configured to map the selected base elements of the circuit design into one or more configurable logic blocks of an FPGA platform, where the configurable logic blocks include one or more of adders and/or counters; implement the one or more defined placement constraints; and generate a placement output for the circuit design based on the mapped base elements and the one or more placement constraints.

In some examples, the configurable logic blocks may further include one or more of subtractors, multipliers, dividers, rotators, shifters, inverters, OR blocks, AND blocks, XOR blocks, XNOR blocks, NAND blocks, NOR blocks, registers, flip-flops, and/or latches. The placement module may also be configured to generate the placement output for a fast adder by split of an adder into two independent portions, a pipelined hybrid lower ripple carry adder “L-RCA” and a pipelined hybrid higher ripple carry adder “H-RCA”, where the H-RCA is configured to receive its carry input from a fast carry generator circuit. A pipeline latency of the fast adder may be dependent on a number of pipeline stages for the H-RCA and the fast carry generator circuit.

In further examples, the placement module may be further configured to implement pipelined latches for a large counter by use of a flip-flop with clock enable and asynchronous preset and clear. The flip-flop may be configured to be preset if an output from a previous carry chain of an adjacent configurable logic block is high and configured to be cleared if the output from the previous carry chain of the adjacent configurable logic block is low. The placement module may be further configured to employ a carry-chain primitive as a hardware primitive.

In yet other examples, the placement module may be further configured to employ a 4-bit adder in a single slice of a configurable logic block; and implement one of a ripple carry adder and a hybrid ripple carry adder from the 4-bit adder on a single slice of the FPGA platform by use of one or more look-up tables (LUTs), multiplexers for carry propagation logic (MUXCYs), XOR gates for computing sum bits (XORCYs), and/or flip-flops (FF). Outputs of the XORCYs may be configured to provide sum bits and outputs of the MUXCYs are configured to provide intermediate carries. To generate the placement output for the circuit design, the placement module may be configured to cascade one or more of ripple carry adders and hybrid ripple carry adders. The circuit design tool may be implemented as one of a locally installed application and a hosted application.

In further examples, a non-transitory computer-readable storage medium is described that includes instructions stored thereon to facilitate design automation of large adders and counters on field programmable gate arrays (FGPAs) through constrained placement. The instructions may be executable by a processor to cause a method to be performed, where the method includes mapping base elements associated with a circuit design to one or more configurable logic blocks of an FPGA platform, where the configurable logic blocks include one or more of adders and/or counters; defining one or more placement constraints for the base elements such that routing and/or interconnect delays in the circuit design and a number of hardware components in the circuit design and/or an occupied chip area are reduced; and generating a placement output associated with the circuit design based on the mapped base elements and the one or more placement constraints.

In yet further examples, the method may further include inserting latches on a carry propagation path for pipelining and implementing a hybrid ripple carry adder from a 4-bit adder on a single slice of the FPGA platform, where the hybrid ripple carry adder includes two or more pipeline stages.

Various embodiments may be implemented in hardware, software, or combination of both hardware and software (or other computer-readable instructions stored on a non-transitory computer-readable storage medium and executable by one or more processors); the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (for example, hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, some aspects of the embodiments disclosed herein, in whole or in part, may be equivalently implemented in integrated circuits, as one or more computer programs running on one or more computers (for example, as one or more programs running on one or more computer systems), as one or more programs running on one or more processors (for example, as one or more programs running on one or more microprocessors), as firmware, or as virtually any combination thereof, and that designing the circuitry and/or writing the code for the software and or firmware are possible in light of this disclosure.

The present disclosure is not to be limited in terms of the particular embodiments described in this application, which are intended as illustrations of various aspects. Many modifications and variations can be made without departing from its spirit and scope Functionally equivalent methods and apparatuses within the scope of the disclosure, in addition to those enumerated herein, will be apparent from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, a solid state drive, etc.; and a transmission type medium such as a digital and/or an analog communication medium (for example, a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A method to provide design automation of large adders and counters on field programmable gate arrays (FPGAs) through constrained placement, the method comprising:
mapping base elements associated with a circuit design to one or more configurable logic blocks of a FPGA platform, wherein the one or more configurable logic blocks include one or more of adders and counters;
defining one or more placement constraints for the base elements during a design synthesis; and
generating a placement output associated with the circuit design based on the mapped base elements and the one or more placement constraints.

2. The method of claim 1, wherein defining the one or more placement constraints includes:
reducing one or more of a routing delay and an interconnect delay in the circuit design.

3. The method of claim 1, wherein defining the one or more placement constraints includes:
reducing a number of hardware components in one or more of the circuit design and an occupied chip area.

4. (canceled)

5. The method of claim 1, further comprising:
employing a carry-chain primitive as a hardware primitive.

6. The method of claim 1, wherein mapping the base elements associated with the circuit design to the one or more configurable logic blocks includes:
employing a 4-bit adder in a single slice of a configurable logic block.

7. The method of claim 6, further comprising:
implementing one of a ripple carry adder and a hybrid ripple carry adder from the 4-bit adder on a single slice of the FPGA platform using one or more look-up tables (LUTs), multhiplexers for carry propagation logic (MUXCYs), XOR gates to compute sum bits (XORCYs), and flip-flops (FF), wherein outputs of the XORCYs correspond to sum bits and outputs of the MUXCYs correspond to intermediate carries.

8. (canceled)

9. The method according to claim 6, further comprising:
implementing a hybrid ripple carry adder from the 4-bit adder on a single slice of the FPGA platform, wherein the hybrid ripple carry adder includes two or more pipeline stages when pipelining is employed.

10. The method of claim 1, further comprising inserting latches on a carry propagation path for pipelining.

11. The method of claim 1, wherein generating the placement output associated with the circuit design comprises:
generating the placement output for the circuit design by cascading one or more of ripple carry adders and hybrid ripple carry adders.

12. The method of claim 1, wherein generating the placement output associated with the circuit design comprises:
generating the placement output for a fast adder by splitting an n-bit adder into two independent portions, a pipelined hybrid lower ripple carry adder (L-RCA) and a pipelined hybrid higher ripple carry adder (H-RCA), each of the two independent portions corresponding to n/2 sum bits, wherein n corresponds to a number of bits that can be processed by the n-bit adder.

13. The method according to claim 1, wherein generating the placement output associated with the circuit design comprises generating the placement output for an up/down counter as a combination of a flip-flop based parallel-in parallel-out (PIPO) register and an incrementer/decrementer, wherein the generated placement output accepts an output of the PIPO register as input, and provides outputs as feedback to an input of the PIPO register.

14. The method of claim 13, wherein generating the placement output associated with the circuit design further comprises:
generating the placement output for a large counter circuit as cascaded stages, wherein the generated placement output of the PIPO register includes a flip-flop with a synchronous reset, a synchronous set, and a synchronous clock enable.

15. (canceled)

16. A circuit design tool to facilitate design automation of large adders and counters on field programmable gate arrays (FPGAs) through constrained placement, the circuit design tool comprising:
a presentation module that includes a graphical user interface (GUI) displayable on a display screen, wherein the presentation module is configured to facilitate definition of one or more placement constraints and selection of base elements associated with a circuit design;
an input module coupled to the presentation module and configured to receive the definition of the one or more placement constraints and the selected base elements through the GUI during a design synthesis; and
a placement module coupled to the input module and configured to:
map the selected base elements of the circuit design into one or more configurable logic blocks of FPGA platform, wherein the one or more configurable logic blocks include one or more of adders and counters;
implement the one or more placement constraints; and
generate a placement output for the circuit design based on the mapped base elements and the one or more placement constraints.

17. The circuit design of claim 16, wherein the one or more configurable logic blocks further include one or more of subtractors, multipliers, dividers, rotators, shifters, inverters, OR blocks, AND blocks, XOR blocks, XNOR blocks, NAND blocks, NOR blocks, registers, flip-flops, and latches.

18. The circuit design tool of claim 16, wherein the placement module is configured to:
generate the placement output for a fast adder by split of an adder into two independent portions, a pipelined hybrid lower ripple carry adder (L-RCA) and a pipelined hybrid higher ripple carry adder (H-RCA), wherein the H-RCA is configured to receive its carry input from a fast carry generator circuit, and wherein a pipeline latency of the fast adder is dependent on a number of pipeline stages for the H-RCA and the fast carry generator circuit.

19. (canceled)

20. The circuit design tool of claim 16, wherein the placement module is further configured to:
implement pipelined latches for a large counter by use of a flip-flop with clock enable and asynchronous preset and clear.

21. The circuit design tool of claim 20, wherein the flip-flop is configured to be preset if an output from a previous carry chain of an adjacent configurable logic block is high and configured to be cleared if the output from the previous carry chain of the adjacent configurable logic block is low.

22. The circuit design tool according to claim 21, wherein the placement module is further configured to employ a carry-chain primitive as a hardware primitive.

23. The circuit design tool of claim 16, wherein the placement module is further configured to:
employ a 4-bit adder in a single slice of a configurable logic block; and
implement one of a ripple carry adder and a hybrid ripple carry adder from the 4-bit adder on a single slice of the FPGA platform by use of one or more look-up tables (LUTs), multiplexers for carry propagation logic (MUXCYs), XOR gates to compute sum bits (XORCYs), and flip-flops (FFs), wherein outputs of the XORCYs correspond to sum bits and outputs of the MUXCYs correspond to intermediate carries.

24. The circuit design tool of claim 23, wherein outputs of the XORCYs are configured to provide sum bits and outputs of the MUXCYs are configured to provide intermediate carries.

25. The circuit design tool of claim 16, wherein to generate the placement output for the circuit design, the placement module is configured to cascade one or more of ripple carry adders and hybrid ripple carry adders.

26. (canceled)

27. A non-transitory computer-readable storage medium that includes instructions stored thereon to facilitate design automation of large adders and counters on field programmable gate arrays (FPGAs) through constrained placement, the instructions being executable by a processor to cause a method to be performed, wherein the method comprises:
mapping base elements associated with a circuit design to one or more configurable logic blocks of a FPGA platform, wherein the one or more configurable logic blocks include one or more of adders and counters;
defining one or more placement constraints for the base elements such that one or more of a routing delay and an interconnect delay in the circuit design and a number of hardware components in one or more of the circuit design and an occupied chip area are reduced; and
generating a placement output associated with the circuit design based on the mapped base elements and the one or more placement constraints.

28. The non-transitory computer-readable storage medium of claim 27, wherein the method further comprises:
inserting latches on a carry propagation path for pipelining; and
implementing a hybrid ripple carry adder from a 4-bit adder on a single slice of the FPGA platform, wherein the hybrid ripple carry adder includes two or more pipeline stages.
